(19) United States
(12) Patent Application Publication
(10) Pub. No.: US 2026/0042333 A1
(43) Pub. Date: Feb. 12, 2026

(54) PORTABLE ELECTRIC CAR AIR CONDITIONER AND REFRIGERATOR

(71) Applicant: PACKARD KLIMA TEKNOLOJILERI SANAYI VE TIC. A.S., Istanbul (TR)

(72) Inventors: Bahadir ACAR, Istanbul (TR); Cevdet ACAR, Istanbul (TR); Mehmet ACAR, Istanbul (TR)

(73) Assignee: PACKARD KLIMA TEKNOLOJILERI SANAYI VE TIC. A.S., Istanbul (TR)

(21) Appl. No.: 19/100,126

(22) PCT Filed: Sep. 6, 2022
(86) PCT No.: PCT/TR2022/050952

§ 371 Date: Jan. 31, 2025

(30) Foreign Application Priority Data
Aug. 4, 2022 (TR) 2022/012366

(51) Int. Cl. B60H 1/00

(52) U.S. Cl. CPC B60H 1/00428; B60H 1/00735; B60H 1/00978; B60H 1/00985

(57) ABSTRACT

A portable electric air conditioner and refrigerator system includes software, sensors, a temperature sensor and a wifi module. The software optimizes the operating time or ambient temperature according to the remaining power of the energy source used. The sensors is configured for measuring energy coming from an energy source (battery) to the portable electric car air conditioner and refrigerator system at all times.

### CROSS REFERENCE TO THE RELATED APPLICATIONS

This application is the national phase entry of International Application No. PCT/TR2022/050952, filed on Sep. 6, 2022, which is based upon and claims priority to Turkish Patent Application No. 2022/012366, filed on Aug. 4, 2022, the entire contents of which are incorporated herein by reference.

### TECHNICAL FIELD

The invention relates to a portable electric air conditioner and refrigerator comprising a software that optimizes the operating time or ambient temperature according to the remaining power of the energy source used.

### BACKGROUND

The invention relates to an innovation made in the electric vehicle air conditioner and refrigerator that can operate through the vehicle battery, described in our patent application numbered 2017/14067. The technique described in the aforementioned application defines a system that can function as an air conditioner and refrigerator with heating and cooling functions without putting additional load on the vehicle's engine with the power it receives from the vehicle's battery. The technical functioning of this system is possible by the presence of an electronic control unit, which provides control of the entire system, and a heater coolant valve, which ensures the change of the working cycle. According to the preference to be made by the user through the electronic control unit, the airflow direction is changed with the heater coolant valve and the user request is fulfilled.

### SUMMARY

The present invention provides a novel portable electric car air conditioner and refrigerator system including:
sensors measuring the energy coming from the energy source (battery) to the system at all times,
software, which can be controlled from the touch screen on the system or from the mobile application, provides cutting off the energy when the energy coming to the sensors is high or very low according to the previously determined standard values, also provides the compressor and the fans, which can operate at different speeds and revolutions, operate at low speed when the energy is below the normal level, also provides the system to continue working at full capacity/speed according to the user's request when the energy in the system returns to normal level,
a temperature sensor, and
a wifi module.

Further, the software measures the temperature outside the vehicle via a temperature sensor and decides in which mode the air conditioning system should work, then regulating the air conditioning heating cooling valve position.

Further, the software includes a user interface that allows user intervention and make settings, to determine how many hours he/she wants to operate the system or the temperature setting of the ambient, showing how many hours the system can operate at the specified temperature by calculating the energy time that the battery can provide according to the user's preferences, the user to see when the battery will run out if the system is used.

Further, the software includes the total load capacity of the battery and the amount of electricity to be consumed according to the level at which it will work, calculates when the battery will run out according to the level at which it will operate, directs the user by sending a notification through the mobile application to charge the battery when the battery is about to run out of capacity after this calculation.

Further, the software constantly checks whether the hardware of the system is working properly, determines that there is a problem in the relevant part if there is a deficiency in the circuits of the connected parts, informs the user at this point about simple operations that can be eliminated by the user, depending on the type of malfunction detected, via the touch screen or mobile application, and transmits the actions to be taken to eliminate the malfunction to the user with visual/video explanations.

Further, the software includes the videos describing the elimination of malfunctions that may occur in every part of the system.

Further, the software plays relevant video according to faulty part.

Further, the software provides technical service information that can be contacted through the mobile application to the user and mediates to contact in case of malfunctions that cannot be corrected by the user.

Further, the software includes the user interface providing the user to select the products that are inside the refrigerator and includes the cooling temperature required by these selected products and automatically adjusting the temperature required by the products inside.

Further, the software takes the weather conditions according to the location data of the vehicle instantly from the database of the public institution that provides the data, determines which weather conditions will be encountered during the vehicle's route, informs the user about the number of hours the system will work by making a calculation according to the weather conditions within the route to be taken, and when it is efficient to fill the battery system according to the air temperatures within the route.

Further, the software takes an average of the user's usage data at defined intervals and assigns the average value as the default value at each start-up.

Further, the portable electric car air conditioner and refrigerator system includes an infrastructure that allows users to create profiles and start to use the system with the preferences which they have determined or with the preferences previously analyzed by the software.

### DETAILED DESCRIPTION OF THE EMBODIMENTS

Within the scope of the invention, the energy coming from the energy source (battery) to the product is always measured by means of sensors. The mentioned sensors are voltmeters and ammeters. As a result of the measurements, when there is a problem in the energy other than the previously determined standard values, means when the energy is high or very low, the energy is automatically cut off by a software in the system with the help of a relay.

The compressors and fans described in the system defined in our patent application numbered 2017/14067 can operate at different speeds and revolutions. The system that is the subject of our invention ensures that the compressors and fans, which can operate at different speeds and revolutions, operate at low speed by the software in the electronic card comprised in the system when the energy, which is monitored as mentioned above by means of voltmeter and ammeter, is below the normal level. When the energy in the system returns to normal level, the system will be able to continue working at full capacity/speed according to the user's request. It is determined by the user through the interface on the mobile application within the system if the system will operate at low speed or return to full capacity operation when the energy returns to its normal level. The aim here is to adjust the speeds of the compressors and fans with the software according to the energy level in the system, to control the energy and to ensure the vehicle's and the product's safety.

By measuring the temperature outside the vehicle by the system, it can be decided in which mode the air conditioning system should work. Decision making process is done by the software. Due to the cold weather in winter, the air conditioning system switches to heating mode and in summer to cooling mode, the vehicle is climatized. Temperature data is taken with the outdoor temperature sensor. Afterwards, this data is processed with the software and it is decided in which position the air conditioning heating cooling valve will be operated. If the heating will work, the air conditioning heating and cooling valve comes to the first position, and if the cooling will work, the second position is reached thanks to the software. In this way, within the scope of the invention, automatic determination of the heating or cooling status is provided via the software.

The software comprised in the system can be controlled from the touch screen on the system or from the mobile application that can work in sync with the system. The interface comprised in the software allows user intervention and settings. Through this interface, the user can determine how many hours he/she wants to operate the system or the temperature setting of the ambient. According to the user's preferences, the current energy time that the battery can provide is calculated by the software and the user is shown how many hours the system can operate at the specified temperature. In this way, the user can see when the battery will run out if the system is used, and can take the necessary precautions accordingly, or keep the ambient at the same temperature for as long as she/he wishes.

The system comprises the total load capacity of the battery in the software. In addition, the amount of electricity to be consumed according to the level at which it will work is also comprised in the software. Thus, it can calculate when the battery will run out according to the level at which it will operate. When the battery is about to run out of capacity after this calculation, it is ensured that the user is directed to charge the battery by sending a notification through the mobile application.

The system constantly checks whether the hardware it comprises is working properly. If there is a deficiency in the circuits of the connected parts, it can be determined that there is a problem in the relevant part. At this point, the system informs the user about simple operations that can be eliminated by the user, depending on the type of malfunction detected, via the touch screen or mobile application, and the actions to be taken to eliminate the malfunction are transmitted to the user with visual/video explanations. In order to do this, videos describing the elimination of malfunctions that may occur in every part of the system have been uploaded to the software. The relevant video is played according to the faulty part. In case of malfunctions that cannot be corrected by the user, technical service information that can be contacted through the mobile application is provided to the user and can be mediated to contact. The intermediary process is in the form of providing the user with the technical service contact numbers comprised in the software.

Through the interface of the software (touch screen or mobile application) within the system, the user can select the products that are inside the refrigerator. The cooling temperature required by these selected products is supplied from among the ideal cooling temperatures of all food products that can be placed in the refrigerator defined in the software. Thus, the software automatically adjusts the temperature required by the products inside. If the number of vegetables is high, it is ensured that the vegetables keep their natural state without getting cold. If meat and perishable products are more, cooling can be done to lower temperatures. If there are beverages such as water, cola and ayran in the refrigerator, the user will be able to adjust the temperature according to which he/she prefers to consume the related beverages.

Batteries discharge quickly in cold weather and take longer to recharge. (https: //inciaku. com/tr/bilgi-merkezi/ani-sicaklik-degisimlerinde-aku-nasil-etkilenir). By using this technical knowledge in our invention, technical effects beyond the state of art have been created. Our product is always connected to the internet via the mobile application or the wifi module it comprises. Via the internet connection, the weather conditions according to the location data of the vehicle are taken instantly from the database of the public institution that provides the data. The user can also choose the route to go from the current location via the interface, and the software determines which weather conditions will be encountered during the vehicle's route from the weather data. At this point, the software informs the user about the number of hours the system will work by making a calculation according to the weather conditions within the route to be taken, and when it is efficient to fill the battery system according to the air temperatures within the route.

The software provides full automation of the process by analyzing user behaviors based on how the product operates, at what temperature values, at what time intervals, how many hours it operates. It does this by averaging the user's usage data at defined intervals. For example, if the user has used between 19 and 21 degrees Celsius for three days, the system takes averages of these values and automatically assigns the average value as the temperature value at each start-up. Therefore, as long as all the settings that can be made by the user within the system are repeated at defined intervals, the average of the values is accepted as the default value by the software. Thus, a more comfortable area is created for the user with the product that recognizes the user.

An important parameter is that the settings change when the people who use the product change. In order to adapt to this, an infrastructure that allows users to create profiles within the software has been established. Users who log in through the mobile application are matched with the product used, and it is ensured that they start using the system in the preferences they have determined through the interface or that the software has previously analyzed as described above and do not need to make adjustments again.

1. A portable electric car air conditioner and refrigerator system, comprising:
sensors for measuring energy coming from an energy source to the portable electric car air conditioner and refrigerator system at all times, wherein the energy source includes a battery,
software, wherein the software is controlled from a touch screen on the portable electric car air conditioner and refrigerator system or from a mobile application, provides cutting off the energy when the energy coming to the sensors is high or low related to previously determined standard values, also provides a compressor and fans, wherein the fans operate at different speeds and revolutions, and operate at low speed when the energy is below the normal level, the software also provides the portable electric car air conditioner and refrigerator system to continue working at a full capacity/speed according to a request of a user when the energy in the portable electric car air conditioner and refrigerator system returns to a normal level,
a temperature sensor, and
a wifi module.

2. The portable electric car air conditioner and refrigerator system of claim 1, wherein the software measures a temperature outside a vehicle via temperature sensor and decides in which mode an air conditioning system should work, and then regulates an air conditioning heating cooling valve position.

3. The portable electric car air conditioner and refrigerator system of claim 1, wherein the software further comprises a user interface, wherein the user interface allows user intervention and makes settings, to determine how many hours the user wants to operate the portable electric car air conditioner and refrigerator system or an ambient temperature setting, the user interface shows how many hours the portable electric car air conditioner and refrigerator system can operate at a specified temperature by calculating an energy time provided by the battery according to preferences of the user, and allows the user to see when the battery will run out if the portable electric car air conditioner and refrigerator system is used.

4. The portable electric car air conditioner and refrigerator system of claim 1, wherein the software further comprises a total load capacity of the battery and an amount of electricity to be consumed according to a level at which the battery will work, calculates when the battery will run out according to the level at which the battery will operate, and directs the user by sending a notification through the mobile application to charge the battery when the battery is about to run out of capacity after the calculation.

5. The portable electric car air conditioner and refrigerator system of claim 1, wherein the software constantly checks checking whether hardware of the portable electric car air conditioner and refrigerator system is working properly, determines that there is a problem in a relevant part if there is a deficiency in circuits of connected parts, informs the user at this point about simple operations for elimination by the user, depending on a type of malfunction detected, via the touch screen or the mobile application, and transmits actions to be taken to eliminate the malfunction to the user with visual/video explanations.

6. The portable electric car air conditioner and refrigerator system of claim 5, wherein the software comprises videos describing the elimination of malfunctions occurring in every part of the portable electric car air conditioner and refrigerator system.

7. The portable electric car air conditioner and refrigerator system of claim 5, wherein the software plays a relevant video according to a faulty part.

8. The portable electric car air conditioner and refrigerator system of claim 5, wherein the software provides technical service information contacted through the mobile application to the user and mediates to contact if malfunctions cannot be corrected by the user.

9. The portable electric car air conditioner and refrigerator system of claim 1, wherein the software further comprises a user interface providing the user to select products inside a refrigerator and comprising a cooling temperature required by the products and automatically adjusting the cooling temperature required by the products inside.

10. The portable electric car air conditioner and refrigerator system of claim 1, wherein the software takes weather conditions according to location data of a vehicle instantly from a database of a public institution providing the location data, determines which weather conditions will be encountered during a route of the vehicle informs the user about working hours of the portable electric car air conditioner and refrigerator system by making a calculation according to the weather conditions within the route to be taken, and when it is efficient to fill a battery system according to air temperatures within the route.

11. The portable electric car air conditioner and refrigerator system of claim 1, wherein the software takes an average value of usage data of the user at defined intervals and assigns the average value as a default value at each start-up.

12. The portable electric car air conditioner and refrigerator system of claim 1, further comprising an infrastructure, wherein the infrastructure allows the user to create profiles and start to use the portable electric car air conditioner and refrigerator system with preferences determined by the user or with preferences previously analyzed by the software.

13. The portable electric car air conditioner and refrigerator system of claim 2, wherein the software further comprises a user interface, wherein the user interface allows user intervention and makes settings, to determine how many hours the user wants to operate the portable electric car air conditioner and refrigerator system or an ambient temperature setting, the user interface shows how many hours the portable electric car air conditioner and refrigerator system can operate at a specified temperature by calculating an energy time provided by the battery according to preferences of the user, and allows the user to see when the battery will run out if the portable electric car air conditioner and refrigerator system is used.

14. The portable electric car air conditioner and refrigerator system of claim 2, wherein the software further comprises a total load capacity of the battery and an amount of electricity to be consumed according to a level at which the battery will work, calculates when the battery will run out according to the level at which the battery will operate, and directs the user by sending a notification through the mobile application to charge the battery when the battery is about to run out of capacity after the calculation.

15. The portable electric car air conditioner and refrigerator system of claim 3, wherein the software further comprises a total load capacity of the battery and an amount of electricity to be consumed according to a level at which the battery will work, calculates when the battery will run out according to the level at which the battery will operate, and directs the user by sending a notification through the mobile application to charge the battery when the battery is about to run out of capacity after the calculation.

16. The portable electric car air conditioner and refrigerator system of claim 2, wherein the software constantly checks whether hardware of the portable electric car air conditioner and refrigerator system is working properly, determines that there is a problem in a relevant part if there is a deficiency in circuits of connected parts, informs the user at this point about simple operations for elimination by the user, depending on a type of malfunction detected, via the touch screen or the mobile application, and transmits actions to be taken to eliminate the malfunction to the user with visual/video explanations.

17. The portable electric car air conditioner and refrigerator system of claim 3, wherein the software constantly checks whether hardware of the portable electric car air conditioner and refrigerator system is working properly, determines that there is a problem in a relevant part if there is a deficiency in circuits of connected parts, informs the user at this point about simple operations for elimination by the user, depending on a type of malfunction detected, via the touch screen or the mobile application, and transmits actions to be taken to eliminate the malfunction to the user with visual/video explanations.

18. The portable electric car air conditioner and refrigerator system of claim 4, wherein the software constantly checks whether hardware of the portable electric car air conditioner and refrigerator system is working properly, determines that there is a problem in a relevant part if there is a deficiency in circuits of connected parts, informs the user at this point about simple operations for elimination by the user, depending on a type of malfunction detected, via the touch screen or the mobile application, and transmits actions to be taken to eliminate the malfunction to the user with visual/video explanations.

19. The portable electric car air conditioner and refrigerator system of claim 6, wherein the software plays a relevant video according to a faulty part.

20. The portable electric car air conditioner and refrigerator system of claim 7, wherein the software provides technical service information contacted through the mobile application to the user and mediates to contact if malfunctions cannot be corrected by the user.
